(19) United States
(12) Patent Application Publication
(10) Pub. No.: US 2024/0279891 A1
(43) Pub. Date: Aug. 22, 2024

(54) APPARATUS AND METHOD FOR MOVING SNOW

(71) Applicant: SYBcon Global LLC, Greensburg, IN (US)

(72) Inventors: Frank Nordyke Strohm, Indianapolis, IN (US); Paul Strohm, Greensburg, IN (US); Karl Strohm, Greensburg, IN (US)

(21) Appl. No.: 18/581,301

(22) Filed: Feb. 19, 2024

Related U.S. Application Data
(60) Provisional application No. 63/446,924, filed on Feb. 20, 2023.

(51) Int. Cl. E01H 5/02; A01B 1/22

(52) U.S. Cl. CPC E01H 5/02; A01B 1/22

(57) ABSTRACT

The present disclosure provides a device for moving snow, comprising: a handle; a blade including a body having a lower edge for engaging a snow covered surface and a front surface facing the handle; and a bracket for connecting the handle to the blade, the bracket being connected to the body of the blade and configured to position the handle in a substantially perpendicular orientation relative to the blade to facilitate pulling the blade toward a user of the device to remove snow from the snow covered surface.

### CROSS-REFERENCE TO RELATED APPLICATIONS

This application claims the benefit under 35 U.S.C. § 119(e) of U.S. Provisional Application No. 63/446,924 filed on Feb. 20, 2023 which is incorporated by reference in its entirety.

### TECHNICAL FIELD

The present invention relates generally to devices for moving snow, and more particularly to an apparatus and method for moving snow using a pulling motion.

### BACKGROUND

Conventional shovels and other similar devices for removing snow from snow covered surfaces require substantial effort and time to use. The conventional process of pushing a shovel into and under snow, then lifting the snow filled shovel to throw the snow load to the side of the path places great strain on the user's back. Moreover, the effort of pushing, lifting and throwing snow can cause substantial stress to the user's cardiovascular system, resulting in thousands of heart attacks each year. Additionally, the process is slow, causing the user to remain in the cold environment for long periods of time. Accordingly, there is a need for an improved apparatus and method for removing snow from a snow covered surface.

### SUMMARY

The present disclosure provides a device for moving snow. The device includes a a handle having a first end and a second end; a blade removably coupled to the second end of the handle, the blade including a body having an upper edge, a lower edge for engaging a snow covered surface, and a front surface facing the handle; and a bracket for connecting the handle to the blade, the bracket being connected to the body of the blade and configured to position the handle in a substantially perpendicular orientation relative to the blade to facilitate pulling the blade toward a user of the device to remove snow from the snow covered surface.

The present disclosure further provides a method for removing snow using a device. The method includes grasping the device; placing the lower edge of the blade down into snow that covers the snow covered surface; pulling the device toward the user; and moving the snow toward the user and off the surface. The device of the method includes a handle having a first end and a second end; a blade removably coupled to the second end of the handle, the blade including a body having an upper edge, a lower edge for engaging a snow covered surface, and a front surface facing the handle; and a bracket for connecting the handle to the blade, the bracket being connected to the body of the blade and configured to position the handle in a substantially perpendicular orientation relative to the blade to facilitate pulling the blade toward a user of the device to remove snow from the snow covered surface;

Finally, the present disclosure provides a multi-purpose device including a handle having a first end and a second end; an attachment mechanism at the second end of the handle, the attachment mechanism comprising a connector configured to removably couple a tool to the handle; and a plurality of tools configured to couple to the handle by the attachment mechanism. The plurality of tools including at least one of a snow removal tool, a duster, an ice removal tool, an ice breaker, a rake, a squeegee a broom, a mop, a paint roller, a duster, and a blade.

In one embodiment, the present disclosure provides a device for moving snow, comprising: a handle; a blade including a body having a lower edge for engaging a snow covered surface and a front surface facing the handle; and a bracket for connecting the handle to the blade, the bracket being connected to the body of the blade and configured to position the handle in a substantially perpendicular orientation relative to the blade to facilitate pulling the blade toward a user of the device to remove snow from the snow covered surface

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 is a perspective view of one embodiment of a snow removal device according to the present disclosure;

FIG. 2 is a perspective view of another embodiment of a snow removal device according to the present disclosure;

FIG. 3 is a top plan view of an attachment mechanism between a handle and a blade of another embodiment of a snow removal device;

FIG. 4 is a perspective view of alternative attachment mechanism according to the present disclosure;

FIG. 5 is a perspective view of another alternative attachment mechanism according to the present disclosure;

FIG. 6 is a perspective view of another alternative attachment mechanism according to the present disclosure;

FIG. 7 is a perspective view of another alternative attachment mechanism according to the present disclosure;

FIG. 8 is a perspective view of another alternative attachment mechanism according to the present disclosure; and

FIG. 9 is a perspective view of another embodiment of the snow removal device that is a multipurpose device that allows for various tools to be attached to the handle of the device.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Throughout the present disclosure and in the claims, numeric terminology, such as first and second, may be used in reference to various components or features. Such use is not intended to denote an ordering of the components or features. Rather, numeric terminology is used to assist the reader in identifying the component or features being referenced and should not be narrowly interpreted as providing a specific order of components or features.

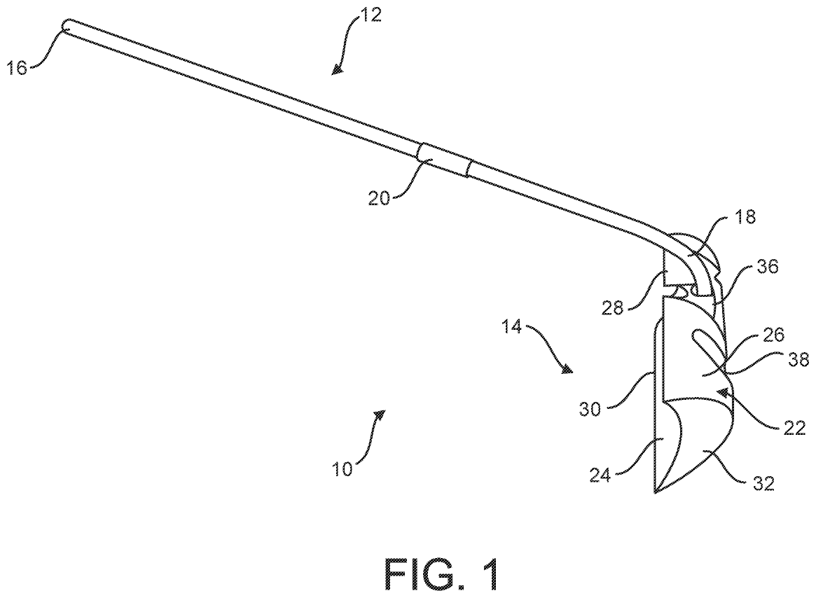

Referring now to FIG. 1, a pull-type manual snow removal device 10 is shown. Device 10 generally includes a handle 12 and a blade 14. Handle 12 includes a first end 16 and a second end 18. The first end 16 and second end 18 may be telescoping such that one of the first end and the second end slide into the other to extend and shorten a total length of handle 12 created by first end 16 and second end 18. Second end 18 includes an attachment mechanism, which in this embodiment is a connection tube 36 as is further described below. As described in other embodiments below, the attachment mechanism may be a bracket, a connector, a coupling, or other suitable connecting feature that allows a tool to be connected to handle 12.

A blade 14 may be removably connected to handle 12 at an attachment mechanism. As shown, first end 16 may be substantially straight and second end 18 may include a curve adjacent the connection to blade 14. First end 16 may be connected to second end 18 with a connector. The connector may be a grip 20. It should be understood that in other embodiments first end 16 includes an insulated grip, or other handle feature and may be curved for ergonomic purposes. In an alternative embodiment, as shown in FIG. 1, grip 20 can be a sliding grip that may be along handle 12 to adjust the position of grip 20 between first end 16 and second end 18. In other embodiments, first end 16 and second end 18 are one piece.

In a first orientation, blade 14 includes a curved body 22 with a front surface 24 that faces the user of device 10 and a rear surface 26 that faces away from the user. Body 22 further includes an upper edge 28 and a lower edge 30. A pair of side walls 32, 34 (only 32 shown) extend along the edges of body 22 between upper edge 28 and lower edge 30. As shown, in this embodiment body 22 and side walls 32, 34 form an interior volume for receiving snow during use. A connection tube 36 extends upwardly from body to receive second end 18 of handle 12, thereby connecting handle 12 to blade 14. It should be understood that any type of connection may be made between tube 36 and second end 18 of handle 12, such as rivets, screws, adhesives, friction, etc. Body 22 may also include at least one rib 38 to increase the rigidity of blade 14.

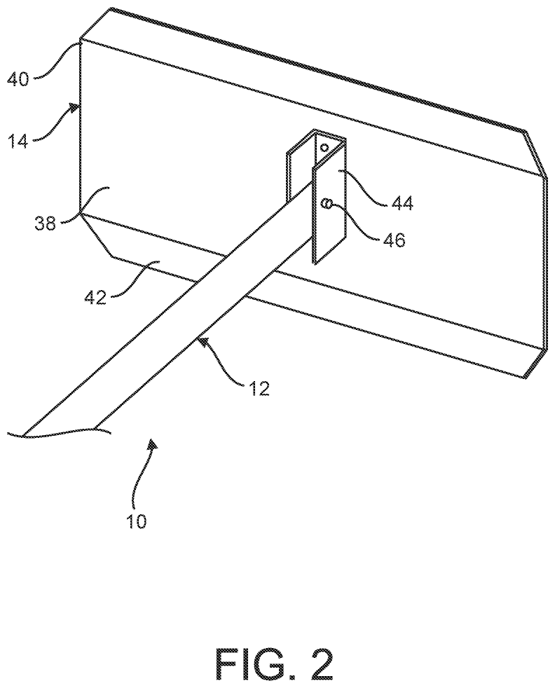

An alternative embodiment of a snow removal device is depicted in FIG. 2. As shown, in this embodiment blade 14 is substantially planar and side walls 32, 34 are omitted. Blade body 22 includes a central section 38, an upper section 40 depending from central section 38 and a lower section 42 depending from central section 38. Upper section 40 and lower section 42 are also substantially planar. Device 10 further includes a bracket 44 connected to central section 38. A fastener 46 or other device is provided to connect bracket 44 to handle 12. In certain embodiments, the angle between blade 14 and handle 12 may be adjusted using bracket 44 and fastener 46 to accommodate users of various different heights. Bracket 44 may be connected to central section 38 at any of a variety of vertical positions.

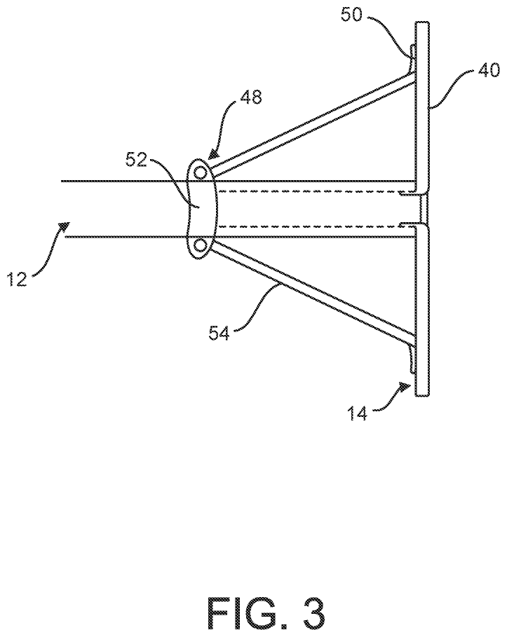

In an alternate embodiment depicted in FIG. 3, device 10 includes a sliding yoke clamp 48 on handle 12 and rigid angled brackets 50 from handle 12 to upper section 40 of blade 14 to adjust the angle of blade 14 relative to handle 12. Yoke clamp 48 includes a sliding collar 52 pivotally connected to a pair of struts 54 which are in turn connected to angled brackets 50. As collar 52 is moved toward or away from blade 14, the angle of blade 14 relative to handle 12 is adjusted. Collar 52 may be configured to lock into a selected position after such adjustment.

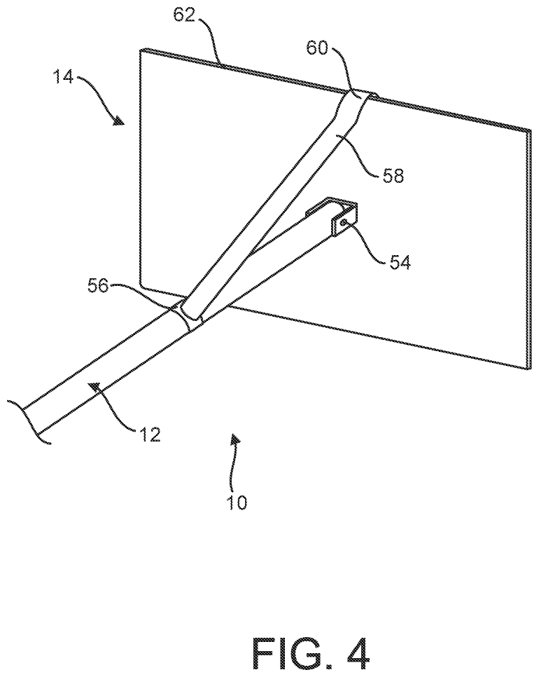

In yet another embodiment as depicted in FIG. 4, handle 12 is pivotally connected to blade 14 by bracket 54. A sliding collar 56 is attached to handle 12 and connected to an arm 58 which includes a U-shaped end 60 that clamps onto upper edge 62 of blade 14. As collar 56 is moved toward or away from blade 14, the angle between blade 14 and handle 12 is adjusted. Collar 56 may be locked in a selected position using any of a variety of different locking mechanisms. In one embodiment, U-shaped end 60 may be biased onto upper edge 62 but may be moved off of upper edge 62 to permit device 10 to be stored in a flat configuration (i.e., with blade 14 pivoted into substantial alignment with handle 12).

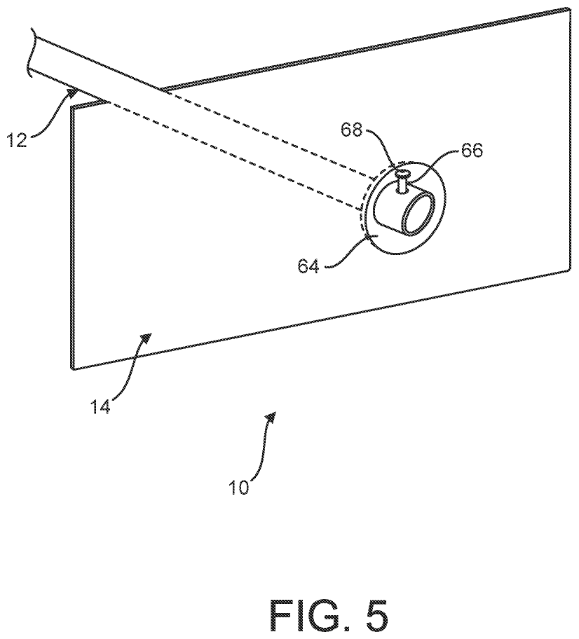

An alternative connection mechanism is depicted in FIG. 5 for connecting handle 12 to blade 14. As shown, a washer 64 is placed over an end of handle 12 and positioned flat against blade 14. The end of handle 12 includes a bore 66. A fastener, such as a cotter pin, 68 is then placed through bore 66 to prevent handle 12 from moving toward the user. A similar washer/bore/cotter pin arrangement is provided on the other side of blade 14 to prevent handle from moving away from the user.

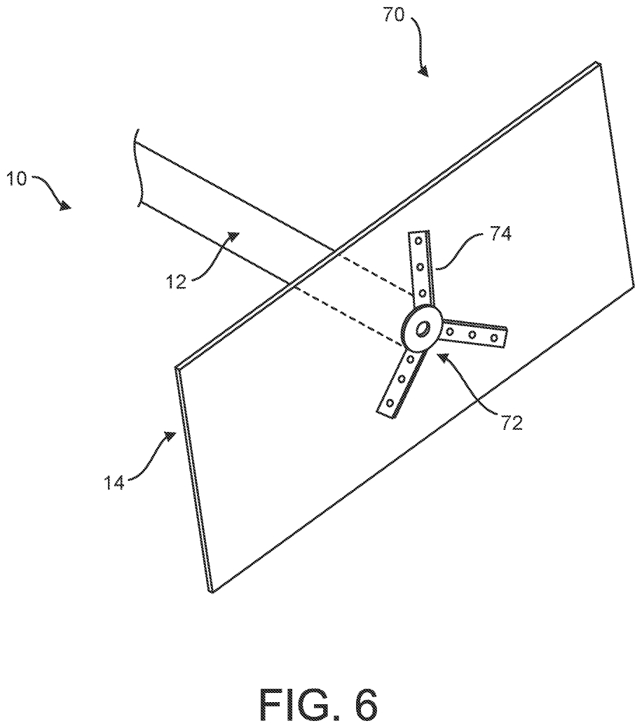

FIG. 6 depicts an alternative attachment mechanism 70 for connecting handle 12 to blade 14. As shown, a bracket 72 including plurality of flanges 74 is connected to one end of handle 12. The flanges 74 extend in a substantially perpendicular direction relative to handle 12 and are attached such as by fasteners or welding to either the front surface or rear surface of blade 14.

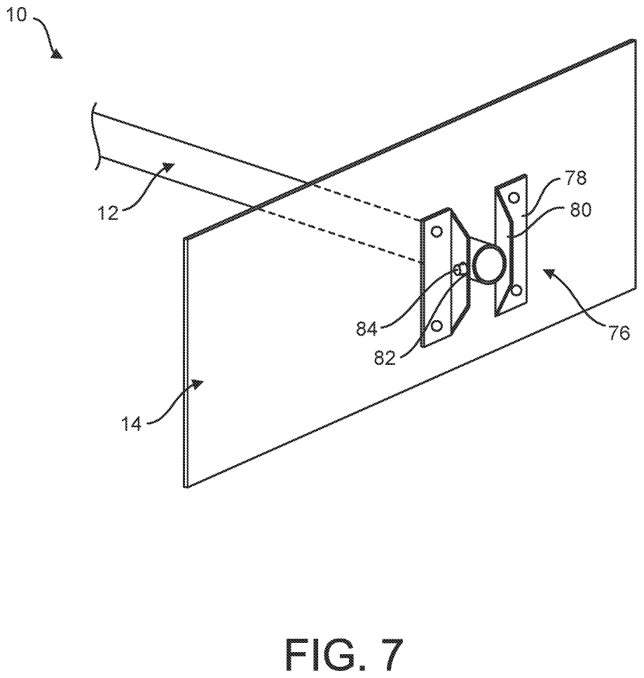

FIG. 7 depicts yet another alternative attachment mechanism 76. In this embodiment, a pair of brackets 78 are attached to the rear surface of blade 14 such as by fasteners or welding. Each bracket 78 includes a perpendicular flange 80 with a central opening 82. In this embodiment, a single pin 84 may be passed through central openings 82 and a bore (not shown) formed through an end of handle 12 to connect handle 12 to blade 14.

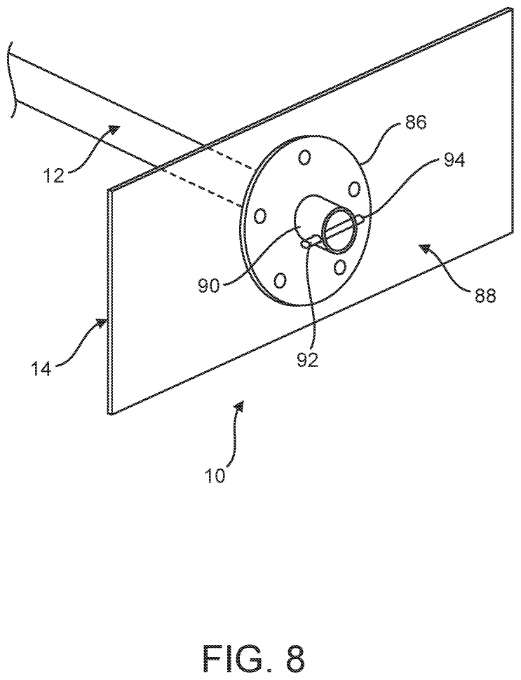

FIG. 8 shows another embodiment of an attachment mechanism 86 for connecting handle 12 to blade 14. In this embodiment, a single bracket 88 with a central tube 90 is connected to blade 14. Central tube 90 includes a pair of aligned, central openings 92. As shown, a single pin 94 may be passed through central openings 92 and a bore (not shown) formed in handle 12 to connect handle 12 to blade 14.

In any of the embodiments disclosed, device 10 may be used by grasping handle 12 and placing lower edge 30 of blade 14 into the snow to be moved and down onto the snow covered surface. The user then pulls device 10 toward the user, thereby moving the snow toward the user and off of the surface. In this manner, the user does not push or lift the snow to remove it from the surface. The many benefits of this manner of snow removal include greatly reduced stress on the user's back and greatly increased speed of snow removal as compared to conventional push and lift methods of snow removal.

In any of the various embodiments disclosed herein, handle 12 and/or blade 14 may be formed from any of a variety of materials including, but not limited to, plastics, metal, wood or other suitable materials. Also, the upper and/or lower edges may be serrated. Moreover, device 10 may include a heating device to heat blade 14. Alternatively, a vibration device may be included to cause blade 14 to vibrate to break up hard snow and/or ice. These devices may be powered by a power source such as AC power from an outlet or DC power from disposable or rechargeable batteries. In yet other embodiments, device 10 may incorporate a salt or deicing solution dispensing device. Additionally or alternatively, the edge of blade 14 that engages the snow covered surface may include rollers to reduce friction. Finally, the edge of blade 14 that engages the snow covered surface may alternatively include a plastic edge or other skid material for friction reduction.

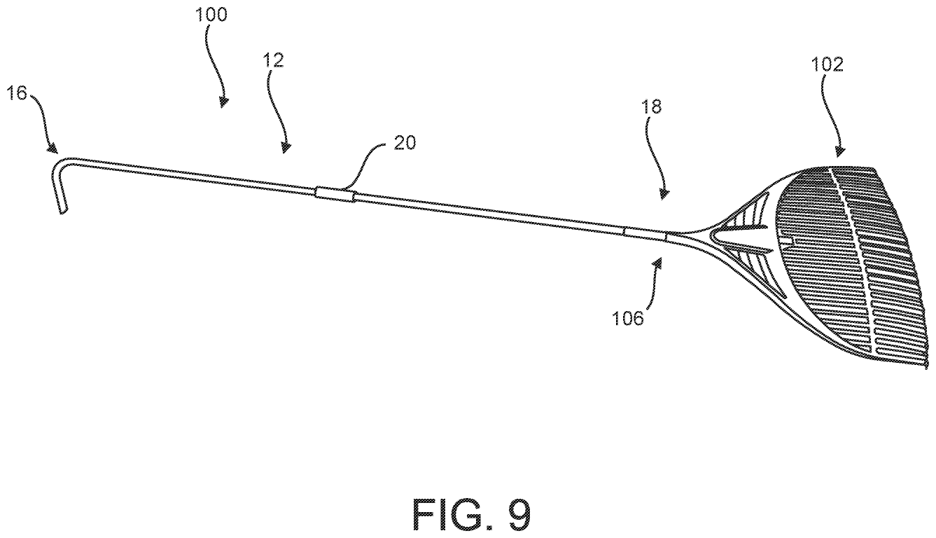

In an alternative embodiment of device 10, as shown in FIG. 9, device 10 may be a multipurpose device 100. The attachment mechanism 106 of multi-purpose device 100 may allow for blade 14 or additional tools 102 to be coupled to second end 18 of handle 12. Such tools 102 that may be coupled to device 10 using one or more of the attachment mechanisms described above may include a snow scraper, an ice removal tool, a snow removal tool, an ice breaker, a rake, a squeegee, a broom, a mop, a paint roller, a duster, or other tools that may benefit from use with handle 12.

Blade 14 may be coupled to handle 12 in the first orientation, as discussed above. Additionally, blade 14 may be coupled to handle 12 in a second orientation. Second orientation includes blade 14 coupled to handle 12 such that front surface 24 faces away from the user of device 10 and rear surface 26 faces the user of device 10. In other words, the handle 12 may be connected to the blade 14 such that the device 10 is oriented in a manner that corresponds to a conventional snow shovel. This may be accomplished, in one embodiment, by connecting the straight end 16 to the connecting tube 36 of FIG. 1.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

The connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, Band C, or A and Band C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A device for moving snow, comprising:
a handle having a first end and a second end;
a blade removably coupled to the second end of the handle, the blade including a body having an upper edge, a lower edge for engaging a snow covered surface, and a front surface facing the handle; and
a bracket for connecting the handle to the blade, the bracket being connected to the body of the blade and configured to position the handle in a substantially perpendicular orientation relative to the blade to facilitate pulling the blade toward a user of the device to remove snow from the snow covered surface.

2. The device of claim 1, wherein the body of the blade is a curved body.

3. The device of claim 1, wherein the blade comprises a pair of side walls, each of the pair of side walls extending along a perimeter of the body between the upper edge and the lower edge.

4. The device of claim 1, wherein the blade comprises a central section, an upper section, and a lower section,
wherein the central section, the upper section, and the lower section are substantially planar.

5. The device of claim 1, further comprising a yoke clamp, the yolk clamp comprising a sliding collar coupled to the handle.

6. The device of claim 5, further comprising a yoke clamp and at least two struts, each of the at least two struts including a first end and a second end;
wherein each of the first ends of the at least two struts are coupled to the sliding collar and each of the second ends of the at least two struts are coupled to an upper section of the blade via a rigid angled bracket.

7. The device of claim 6, wherein the sliding collar is configured to change an angle of the blade relative to the handle when the sliding collar is moved up and down the handle.

8. The device of claim 1, further comprising a grip coupled to the first end of the handle.

9. The device of claim 8, wherein the grip is an insulated grip.

10. The device of claim 8, wherein the grip is a sliding grip configured to be adjusted up and down the handle.

11. The device of claim 1, wherein the first end and the second end are a unitary piece.

12. The device of claim 1, wherein the first end and the second end are configured to be telescoping.

13. A method of removing snow using a device, comprising:
grasping the device, the device comprising:
a handle having a first end and a second end;
a blade removably coupled to the second end of the handle, the blade including a body having an upper edge, a lower edge for engaging a snow covered surface, and a front surface facing the handle; and
a bracket for connecting the handle to the blade, the bracket being connected to the body of the blade and configured to position the handle in a substantially perpendicular orientation relative to the blade to facilitate pulling the blade toward a user of the device to remove snow from the snow covered surface;
placing the lower edge of the blade down into snow that covers the snow covered surface;
pulling the device toward the user; and
moving the snow toward the user and off the surface.

14. The method of claim 13, wherein moving the snow toward the user includes removing the snow from the surface without pushing or lifting the device.

15. A multi-purpose device, comprising:
a handle having a first end and a second end;
an attachment mechanism at the second end of the handle, the attachment mechanism comprising a connector configured to removably couple a tool to the handle; and
a plurality of tools configured to couple to the handle by the attachment mechanism, the plurality of tools including at least one of a snow removal tool, a duster, an ice removal tool, an ice breaker, a rake, a squeegee, a broom, a mop, a paint roller, a duster, or a blade.

16. The multi-purpose device of claim 15, wherein one of the plurality of tools is the blade, the blade including a body having an upper edge, a lower edge for engaging a snow covered surface, and a front surface.

17. The multi-purpose device of claim 16, wherein the blade is connected to the handle by the attachment mechanism in a first orientation such that the front surface of the blade faces the handle.

18. The multi-purpose device of claim 16, wherein the blade is connected to the handle by the attachment mechanism in a second orientation such that the front surface of the blade faces away from the handle.

19. The multi-purpose device of claim 15, further comprising a heating device configured to heat at least one of the plurality of tools.

20. The multi-purpose device of claim 15, further comprising a dispensing device configured to dispense at least one of salt and a deicing solution onto at least one of the tool or a surface directly adjacent to the tool.
